(19) United States
(12) Patent Application Publication
(10) Pub. No.: US 2011/0202851 A1
(43) Pub. Date: Aug. 18, 2011

(54) System and Method for Online Collaborative Creative Writing Process

(76) Inventors: Christopher TWYMAN, Cambridge, MA (US); Ian Garland, Nottingham (GB)

(21) Appl. No.: 13/026,019

(22) Filed: Feb. 11, 2011

Related U.S. Application Data
(60) Provisional application No. 61/304,279, filed on Feb. 12, 2010.

(51) Int. Cl. G06F 3/048

(52) U.S. Cl. 715/751

(57) ABSTRACT

A system and process for online collaborative writing between a plurality of users for a creative book. The present invention allows users to collectively write a new book with users voting upon the most favorite chapters written among the community. The users of the community are monitored and managed by a group of administrators. The administrators are managed by a super administrator. The objective of the present invention is to create an online community that is able to author new and creative books.

The current application claims a priority to the U.S. Provisional Patent application Ser. No. 61/304,279 filed on Feb. 12, 2010.

### FIELD OF THE INVENTION

The present invention relates generally to a flow process for collaborative writing on an internet network. The objective of the present invention is to provide a process and system for a plurality of users or writers to contribute to a plurality of stories.

### BACKGROUND OF THE INVENTION

Traditionally, the process of writing a book can take authors a period of anywhere from a few days to years. To quickly write a book, the author is required intense and constant creativity. However, many authors often find themselves stuck in a writer's block. The present invention is a system and method that provides a group of users with a collaborative writing experience that can produce books of different categories. The present invention is an online application that enables a collaborative creative writing process for a plurality of individuals. These individuals can start their own first chapter of a story in the application and have any other user to contribute to the second chapter within a predetermined time frame. Each of the other users is able to contribute their own versions of a follow chapter within the predetermined time frame. The submitted versions of the follow chapter are then reviewed by each of the different users and a favorite submission is voted upon as the chapter to follow the preceding chapter. This process repeats until a predetermined number of chapters have been completed. The present invention allows a number of individual writers to collaborate in the writing of a book. With a plurality of different writers, the amount of creativity is much greater than the creativity of a single writer. The system and method presented by the present invention is able to nurture a large creative community producing many creative works for the enjoyment of others.

### BRIEF DESCRIPTION OF THE DRAWINGS

FIG. 1 is a flow diagram of the process of creating a new book with the present invention.

FIG. 2 is a flow diagram of the process of the competition process of additional chapters.

FIG. 3 is a flow diagram of the process for managing a homepage for a book.

FIG. 4 is a tree diagram of a user's homepage, an admin's homepage, and a super admin's homepage.

### DETAIL DESCRIPTIONS OF THE INVENTION

All illustrations of the drawings are for the purpose of describing selected versions of the present invention and are not intended to limit the scope of the present invention.

The present invention is an online application system that provides users with a collaborative creative writing experience for the production of books of different categories that can be enjoyed by any individual. The system provided by the present invention comprises of a user homepage 1, an administrator homepage 2, a super administrator homepage 3, and a book entry database 4. The present invention has three different types of users to run the system including the regular users, the administrators and the super administrators. The regular users are the everyday writers and readers who wish to contribute to the collaborative writing community provided by the present invention. The regular users are able to interface with the present invention by means of the user homepage 1. To manage the users, the present invention also provides administrators. The administrators are able to interface with the present invention by means of the administrator homepage 2. The administrators are responsible for the management of the users who contribute to specific creation of a writing of the books. The administrators also have the ability to control the users' accounts and manage a plurality of book entries 41. To manage the administrators, the present invention also provides super administrators. The super administrators are able to control all aspects of the system provided by the present invention and mainly manage the administrators. The super administrators access and interface the present invention by means of the super administrator homepage 3. All the different homepage interfaces for each type of users are operated from a common system database server.

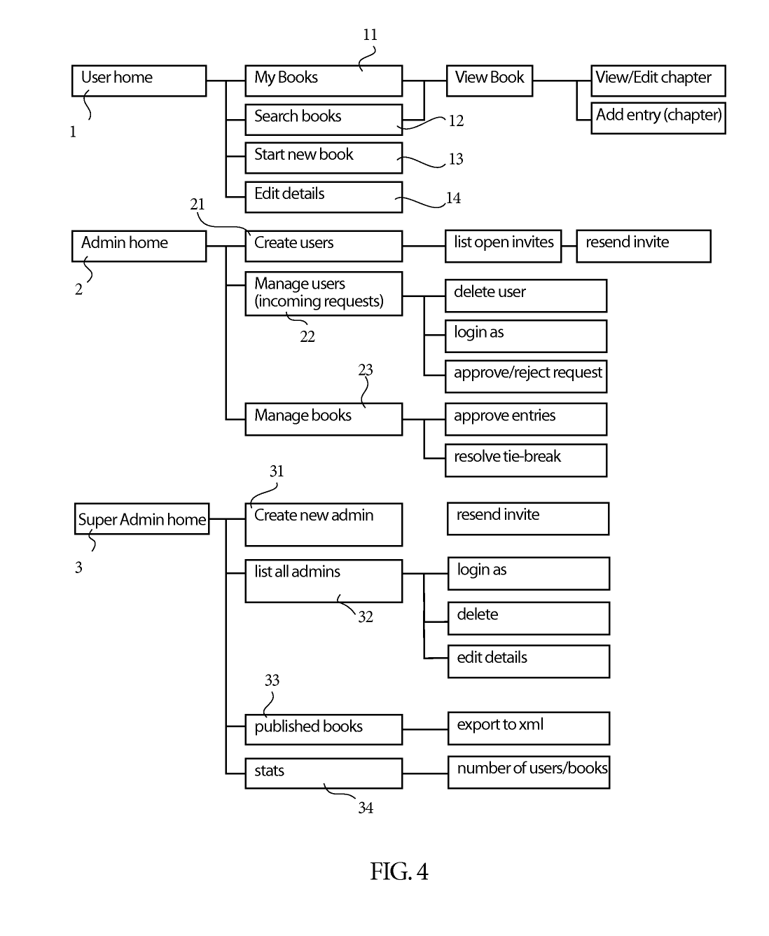

In reference to FIG. 4, the users access the present invention through the user homepage 1. The user homepage 1 comprises of a personal books subpage 11, a book search subpage 12, a create book subpage 13, and a detail editing subpage 14. The personal books subpage 11 displays for the user a list of a plurality of personal books that they have contributed to creating or have marked as one of their favorite books. The personal books subpage 11 also provides the user with the option to add and edit entries to the books they have contributed. The book search subpage 12 provides the user with a search engine to find a specific book. Similar to the personal books subpage 11, the book search subpage 12 is able to display a list of the plurality of books related to the search term the user inputted into the search engine. The displayed list provides the user with the option to add or edit entries to the books they wish and have the opportunity to contribute. The book creation subpage provides the users with the means to initiate the creation of a new book. When the user wishes to initiate the creation of a new collaborative writing book, they are able to access the book creation subpage to submit a first chapter. Each of the users is provided with a user profile which they are able to edit their own personal information. The detail editing subpage 14 provides the user with means to edit the details of the user profile for their own corresponding user homepage 1. The information they can include for the user profile includes their interests, their age, their contact information, or any other information they wish to share about themselves to the collaborative writing community provided by the present invention.

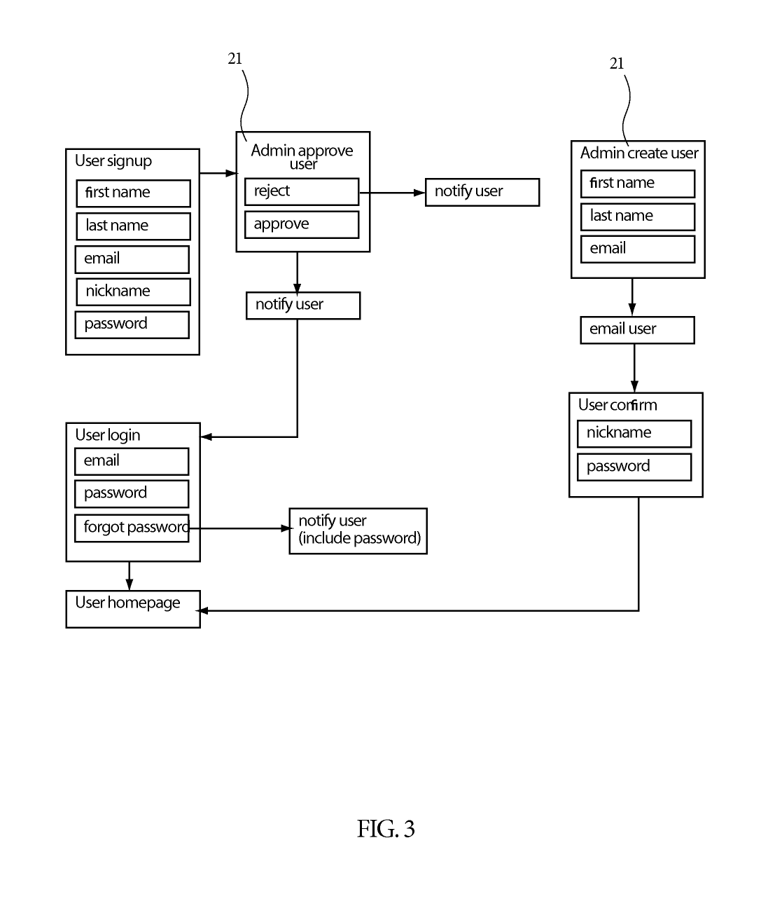

In reference to FIG. 4, the administrators access the present invention through the administrator homepage 2. The administrator homepage 2 comprises of a user creation subpage 21, a user management subpage 22, and a book management subpage 23. The user creation subpage 21 provides the administrators with the ability to invite the users to contribute in the collaboration for the creation of a plurality of books. If the users do not respond the initial invitation, the administrators can use the user creation subpage 21 to resend the invitations to users. The administrators of the system provided by the present invention have the responsibility of ensuring that the system and its users are orderly and running smoothly. To do so, the administrators have control over the users and their actions. The administrator is able to manage the users through the user management subpage 22. In reference to FIG. 3, the user management subpage 22 provides the administrator with the means to delete users and restricting their access to the system. The user management system also provides the administrator the means to login as certain users. Additionally the user management subpage 22 provides the administrator with the means to approve or reject requests made by the users. These functionalities allow the administrator to deal with delinquent users, users who have forgotten their passwords, or users who wish to take certain actions. The restrict access to system for the delinquent users, help users reset their passwords for access, or grant requests to users by means of the user management subpage 22. The book management subpage 23 provides the administrator the means to review and approve entries to initiate or continue the collaborative writing for the plurality of books. The book management subpage 23 also provides the administrators with the any other abilities for the management of the plurality of books being created by the users.

In reference to FIG. 4, the super administrator accesses the present invention through the super administrator homepage 3. The super administrator homepage 3 comprises of an admin creation subpage 31, an administrator list subpage 32, a published book subpage 33, and a statistics subpage 34. The super administrators being the managers for the administrators have the top level of management capabilities for the present invention. The super administrators access the admin creation subpage 31 to send invitations and resend invitations to the users who wish to become administrators. The super administrators are then able to choose the users who are to be the leaders of the online collaborative creative writing community. To monitor each of the administrators, the super administrator is provided with the administrator list subpage 32. The administrator list subpage 32 displays all of the individual administrators and provides the super administrator with management capabilities. Similar to the administrator's capabilities to manage the users, the super administrator is able to have the same capabilities for each administrator. The administrator list subpage 32 provides the super administrators the means to login as certain administrators. The administrator list subpage 32 also provides the super administrators the ability to restrict administrator capabilities by deleting administrators. The restriction of administrator capabilities may be performed when an administrator abuses his/her power in the collaborative writing community. Additionally, the administrator list subpage 32 provides the super administrators with the ability to edit the profile details of each administrator. This allows the super administrators to tag each administrator. By tagging each administrator, the users are able to know who they can contact when they are in need of help. The published book subpage 33 provides the super administrators with the means to export any of the published books that were created through the collaborative writing process introduced by the present invention. The at least one published books can be exported into an XML format to be handled electronically. The statistics subpage 34 provides the super administrators with the statistics of the users and the plurality of book entries 41. The statistical information provided by the statistics subpage 34 can show the progress and growth of the collaborative writing community.

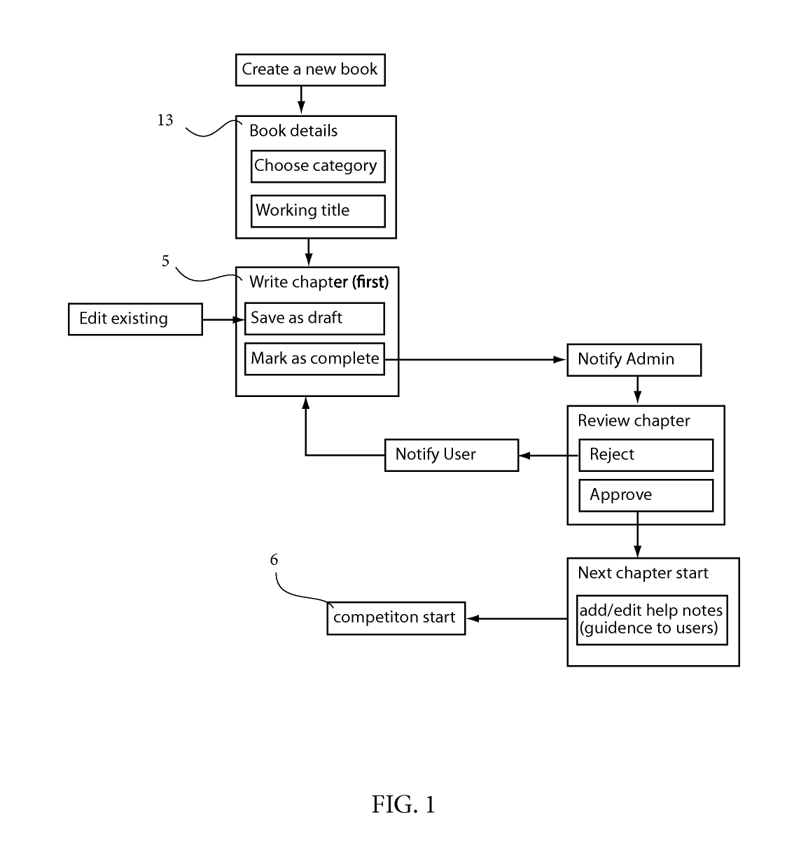

With each types of user given their own capabilities through each of their own respective homepages, the system provides the tools for the users to collaboratively create books. In reference to FIG. 1, to start a book, the user can access the book creation subpage to begin drafting an initial chapter 5 for a new book entry. The user will first choose the category/genre of the book and create a working title for the book to be written. Once the category and the title of the book are chosen, the book is created and will show up in the user's personal books subpage 11. The user can begin to write the initial chapter 5 of the book. At any point in time, the user has the means to save their work and come back to add and edit the initial chapter 5 by accessing the personal books subpage 11 or the book search subpage 12. Once the initial chapter 5 is completed and fully edited, the user can mark the initial chapter 5 as complete. The marking of the initial chapter 5 as completed will notify the administrator of the completion. The administrator will then review the initial chapter 5 to be approved or rejected for proceeding with the online collaborative writing process. If for any reason the initial chapter 5 is rejected, the user that initiated the new book entry will be notified about the rejection with notes and reasons of rejection. If the initial chapter 5 of the new book entry is approved, the new book entry will initiate a series of chapter writing competition 6s. The number of chapters to be written is predetermined by the user or the administrator in charge of overseeing the completion of the new book entry.

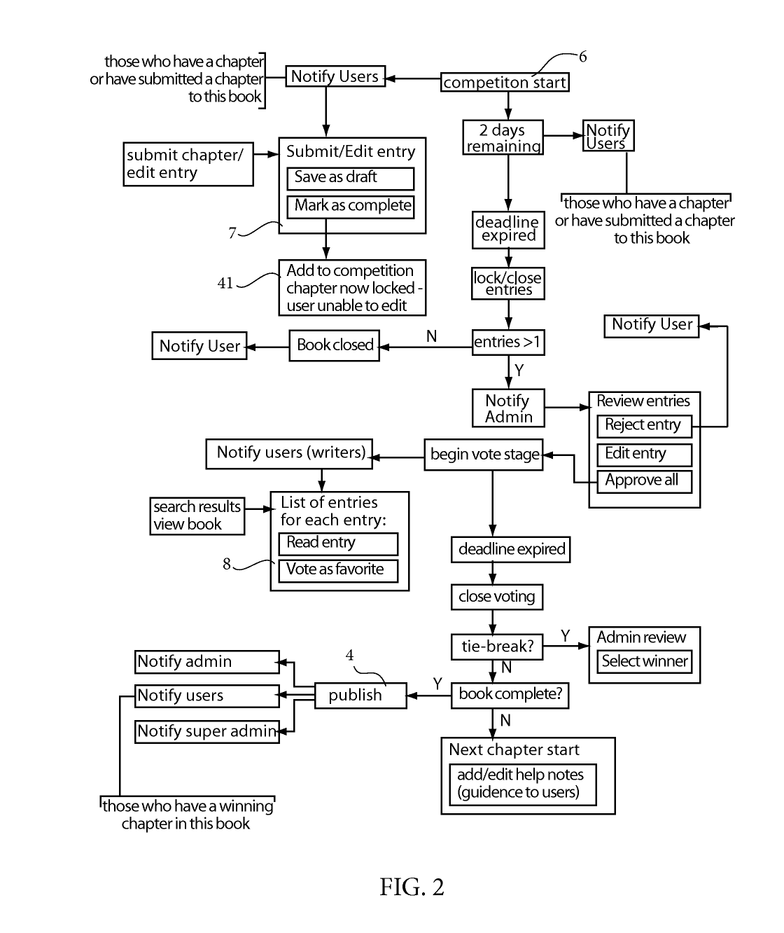

In reference to FIG. 2, at the beginning of the series of chapter writing competition 6s, the administrator is able to invite a plurality of users to join in the contribution for the creation of the new book entry. The invited users will be notified of the beginning of the collaborative writing competition. Each chapter for the series of chapter writing competition 6 occurs for a predetermined time period. The users who were invited to contribute to the new book entry will each write their own versions of the following chapter for submission. Alike the initial chapter 5, the users are able to save their versions of the following chapter to the book entry database 4 provided by the present invention as a draft and later return to complete or edit their writings. Each of the invited users is able to access the personal books subpage 11 or the book search subpage 12 to access the new book entry. Once the users mark their submitted entries of the follow chapter as completed, the submitted entry 7 is locked from further editing and is added to the series of chapter writing competition 6 for later review. Before the predetermined time period expires, all the contributing users for the series of writing chapter competition are notified. Once the predetermined time period has expired, each of the submitted entries is locked in. The locking in of each submitted entry 7 prevents the users from further editing or adding to their versions of the chapter. If there is less than one submitted entry 7, the series of chapters writing competition is closed and the new book entry is put to a stop. The closing of the series of chapters writing competition will be notified to each of the users who have contributed to the new book entry. If there is more than one submitted entry 7, the administrator is notified to review each of the submitted entries for rejection, editing, and approval. The approved versions of the chapter will enter a voting stage 8. If a submitted entry 7 is rejected, the user who authored the chapter will be notified. Once all of the submitted entries have passed review by the administrator, the voting stage 8 is initiated. The users are then notified of the initiation of the voting stage 8. The user are able to then access the personal book subpage or the book search subpage 12 to further access the new book entry to read sets of the approved submitted entries from the book entry database 4. After reading each version of the chapter, they are able to vote for their favorite version of the set. To read every single chapter, the users are able to access another set of the chapter and vote for their favorite of the set. The chapters included in each set are predetermined by the system of the present invention to ensure that there is equal distribution. The voting stage 8 lasts for a predetermined voting time. Once the predetermined voting time expires, the voting stage 8 is locked from any additional voting by the users. The submitted entry 7 that received the most votes is included as a chapter of the new book entry from the series of new chapter writing competitions. In the case of a tie, the administrator will read the tied entries for chapter and break the tie. The administrator will decide on the winning submitted entry 7 to be included as the follow chapter. If the new book entry is not completed, the series of chapter writing competition 6 is continued and is reinitiated for another chapter. Once the chapter writing competition restarts, the administrator is able to offer the collaborating users some guidance notes. If the new book entry is completed, the book is published into the book entry database 4 and the contributing users, the administrators, and the super administrator are notified.

The method and process of creating a new book through collaborative writing allows the present invention to combine the creativity of a plurality of writers. Such books also have an increased potential to be popular among readers as the most favorite chapters are voted upon during the creation of each chapter.

Although the invention has been explained in relation to its preferred embodiment, it is to be understood that many other possible modifications and variations can be made without departing from the spirit and scope of the invention as hereinafter claimed.

What is claimed is:

1. A system for an online collaborative creative writing process comprises,
a user homepage;
a administrator homepage;
a super administrator homepage;
a book entry database;
the user homepage comprises of a personal books subpage, a book search subpage, a create book subpage, and an detail editing subpage;
the administrator homepage comprises of a user creation subpage, a user management subpage, and a book management subpage; and
the super administrator homepage comprises of an admin creation subpage, a administrator list subpage, a published book subpage, and a statistics page.

2. A method for using the system for an online collaborative creative writing process comprises,
providing users, administrators, and super administrators;
providing a user homepage;
providing an administrator homepage;
providing a super administrator homepage;
providing a book entry database;
the book entry database having a plurality of book entries;
the users accessing the user homepage;
the administrators accessing the administrator homepage;
the super administrators accessing the super administrator homepage;
the user homepage comprises of a personal books subpage, a book search subpage, a create book subpage, and a detail editing subpage;
the administrator homepage comprises of a user creation subpage, a user management subpage, and a book management subpage; and
the super administrator homepage comprises of an admin creation subpage, an administrator list subpage, a published book subpage, and a statistics page.

3. The method for using the system for an online collaborative creative writing process as claimed in claim 2 comprises,
the personal books subpage displaying a plurality of books and providing the option to add and edit entries to the books;
the book search subpage providing a search engine to find specific books and providing the option to add and edit entries to the books;
the book creation subpage providing means to initiate the creation of a new book; and
the detail editing subpage providing means to edit details of a user profile for the user homepage.

4. The method for using the system for an online collaborative creative writing process as claimed in claim 2 comprises,
the user creation subpage providing the administrator means to invite users to contribute to the creation of a plurality of books;
the user creation subpage providing the administrator means to resend invitation to users to contribute to the creation of a plurality of books;
the user management subpage providing the administrator means to delete users;
the user management subpage providing the administrator means to login as certain users;
the user management subpage providing the administrator means to approve or reject requests for users;
the book management subpage providing the administrator means to approve entries to books; and
the book management subpage providing the administrator means to resolve voting tie breaks for entries to books.

5. The method for using the system for an online collaborative creative writing process as claimed in claim 2 comprises,
the admin creation subpage providing the super administrator means to send invitations and resend invitations to the users to become the administrators;
the administrator list subpage providing the super administrators means to login as certain administrators;
the administrator list subpage providing the super administrators means to delete administrators;
the administrator list subpage providing the super administrators means to edit profile details of the administrators;
the published book subpage providing the super administrators the means to export at least one published book to an xml format; and
the statistics subpage displaying the statistics of the users and the plurality of books entries.

6. The method for using the system for an online collaborative creative writing process as claimed in claim 2 comprises,
the user accessing the book creation subpage to create a new book entry by providing a category and a working title;
the user writing an initial chapter to be saved as a draft or marked as completed being stored into the book entry database;
the user having means to edit the initial chapter;
the marking of the initial chapter as completed notifying the administrators;
reviewing of the initial chapter by the administrators for rejection or approval;
the rejection of the initial chapter notifying the user;
the approval of the initial chapter providing the user with guidance notes to the users; and
the approval of the initial chapter initiating a series of chapter writing competition.

7. The method for using the system for an online collaborative creative writing process as claimed in claim 6 comprises,
the administrator accessing the user creation subpage to send invitation to users to contribute to participate in the series of chapter writing competition;
wherein the initiating of the series of chapter writing competition notifies the invited users; and
wherein each chapter writing competition of the series of chapter writing competition occurs for a predetermined time period.

8. The method for using the system for an online collaborative creative writing process as claimed in claim 7 comprises,
the users accessing the personal books subpage to submit or edit entries to the book for the series of chapter writing competition;
marking of the submitted entry to the book to be added to the series of chapter writing competition; and
locking of the submitted entry to prevent further editing.

9. The method for using the system for an online collaborative creative writing process as claimed in claim 8 comprises,
wherein the users are notified before the predetermined time period expires;
expiring of the predetermined time period locking all submitted entries;
wherein if there is less than one submitted entry, the series of chapters writing competition is closed and the user is notified;
wherein if there is more than one submitted entry, the administrator is notified to review each of the submitted entries for rejection, editing, and approval;
wherein the approved submitted entries being entered into a voting stage;
initiating of the voting stage by the administrator notifying the users;
the user accessing the personal book subpage or the book search subpage to further access and read the approved submitted entries from the book entry database and voting for a single entry as favorite;
the voting stage lasting for a predetermined voting time;
expiring of the predetermined voting time locking the voting stage from additional voting by the users; and
wherein a winning submitted entry is included as a chapter of the new book entry from the series of new chapter writing competition.

10. The method for using the system for an online collaborative creative writing process as claimed in claim 9 comprises,
wherein the voting stage results in a tie requiring a tie break from the administrator;
reviewing of tied submitted entries by the administrators; and
selecting of the winning submitted entry by the administrator.

11. The method for using the system for an online collaborative creative writing process as claimed in claim 9 comprises,
the voting stage providing each users with a set of the approved submitted entries to read and voted upon; and
the users accessing the voting stage repeatedly until they are able to read every approved submitted entry if desired.

12. The method for using the system for an online collaborative creative writing process as claimed in claim 9 comprises,
wherein the new book entry is not completed for the continuation of the series of chapter writing competition; and
wherein the series of chapter writing competition is reinitiated.

13. The method for using the system for an online collaborative creative writing process as claimed in claim 9 comprises,
publishing of the new book entry when the new book entry is completed; and
notifying the administrator, the users, and the super administrator of completion of the new book entry.

14. A method for using the system for an online collaborative creative writing process comprises,
providing users, administrators, and super administrators;
providing a user homepage;
providing an administrator homepage;
providing a super administrator homepage;
providing a book entry database;
the book entry database having a plurality of book entries;
the users accessing the user homepage;
the administrators accessing the administrator homepage;
the super administrators accessing the super administrator homepage;
the user homepage comprises of a personal books subpage, a book search subpage, a create book subpage, and a detail editing subpage;
the administrator homepage comprises of a user creation subpage, a user management subpage, and a book management subpage;
the super administrator homepage comprises of an admin creation subpage, an administrator list subpage, a published book subpage, and a statistics page;
the personal books subpage displaying a plurality of books and providing the option to add and edit entries to the books;
the book search subpage providing a search engine to find specific books and providing the option to add and edit entries to the books;
the book creation subpage providing means to initiate the creation of a new book;
the detail editing subpage providing means to edit details of a user profile for the user homepage;
the user creation subpage providing the administrator means to invite users to contribute to the creation of a plurality of books;
the user creation subpage providing the administrator means to resend invitation to users to contribute to the creation of a plurality of books;
the user management subpage providing the administrator means to delete users;
the user management subpage providing the administrator means to login as certain users;
the user management subpage providing the administrator means to approve or reject requests for users;
the book management subpage providing the administrator means to approve entries to books;
the book management subpage providing the administrator means to resolve voting tie breaks for entries to books;
the admin creation subpage providing the super administrator means to send invitations and resend invitations to the users to become the administrators;
the administrator list subpage providing the super administrators means to login as certain administrators;
the administrator list subpage providing the super administrators means to delete administrators;
the administrator list subpage providing the super administrators means to edit profile details of the administrators;
the published book subpage providing the super administrators the means to export at least one published book to an xml format;
the statistics subpage displaying the statistics of the users and the plurality of books entries;
the user accessing the book creation subpage to create a new book entry by providing a category and a working title;
the user writing an initial chapter to be saved as a draft or marked as completed being stored into the book entry database;
the user having means to edit the initial chapter;
the marking of the initial chapter as completed notifying the administrators;
reviewing of the initial chapter by the administrators for rejection or approval;
the rejection of the initial chapter notifying the user;
the approval of the initial chapter providing the user with guidance notes to the users; and
the approval of the initial chapter initiating a series of chapter writing competition.

15. The method for using the system for an online collaborative creative writing process as claimed in claim 14 comprises,
the administrator accessing the user creation subpage to send invitation to users to contribute to participate in the series of chapter writing competition;
wherein the initiating of the series of chapter writing competition notifies the invited users; and
wherein each chapter writing competition of the series of chapter writing competition occurs for a predetermined time period.

16. The method for using the system for an online collaborative creative writing process as claimed in claim 15 comprises,
the users accessing the personal books subpage to submit or edit entries to the book for the series of chapter writing competition;
marking of the submitted entry to the book to be added to the series of chapter writing competition; and
locking of the submitted entry to prevent further editing.

17. The method for using the system for an online collaborative creative writing process as claimed in claim 16 comprises,
wherein the users are notified before the predetermined time period expires;
expiring of the predetermined time period locking all submitted entries;
wherein if there is less than one submitted entry, the series of chapters writing competition is closed and the user is notified;
wherein if there is more than one submitted entry, the administrator is notified to review each of the submitted entries for rejection, editing, and approval;
wherein the approved submitted entries being entered into a voting stage;
initiating of the voting stage by the administrator notifying the users;
the user accessing the personal book subpage or the book search subpage to further access and read the approved submitted entries from the book entry database and voting for a single entry as favorite;
the voting stage lasting for a predetermined voting time;
expiring of the predetermined voting time locking the voting stage from additional voting by the users; and
wherein a winning submitted entry is included as a chapter of the new book entry from the series of new chapter writing competition.

18. The method for using the system for an online collaborative creative writing process as claimed in claim 17 comprises,
wherein the voting stage results in a tie requiring a tie break from the administrator;
reviewing of tied submitted entries by the administrators; and
selecting of the winning submitted entry by the administrator.

19. The method for using the system for an online collaborative creative writing process as claimed in claim 17 comprises,
the voting stage providing each users with a set of the approved submitted entries to read and voted upon;
the users accessing the voting stage repeatedly until they are able to read every approved submitted entry if desired;
wherein the new book entry is not completed for the continuation of the series of chapter writing competition;
wherein the series of chapter writing competition is reinitiated;
publishing of the new book entry when the new book entry is completed; and
notifying the administrator, the users, and the super administrator of completion of the new book entry.
